(19) United States
(12) Patent Application Publication
(10) Pub. No.: US 2020/0027406 A1
(43) Pub. Date: Jan. 23, 2020

(54) ELECTRONIC MIRROR APPARATUS

(71) Applicant: Panasonic Intellectual Property Management Co., Ltd., Osaka (JP)

(72) Inventors: YUTAKA KANAZAWA, Kanagawa (JP); HIROSHI HAGIWARA, Kanagawa (JP)

(21) Appl. No.: 16/497,787

(22) PCT Filed: Feb. 19, 2018
(86) PCT No.: PCT/JP2018/005642

§ 371 Date: Sep. 25, 2019

(30) Foreign Application Priority Data
Mar. 31, 2017 (JP) 2017-070747

(51) Int. Cl. G09G 3/34; G09G 3/36; B60R 1/12; B60R 1/00

(52) U.S. Cl. CPC G09G 3/3406; G09G 3/36; B60R 1/12; B60R 1/00; B60R 2300/8066; G09G 2320/0626; G09G 2360/144; G09G 2354/00; B60R 2001/1215; G09G 2380/10

(57) ABSTRACT

An electronic mirror apparatus includes a display unit, an optical mirror, a mode switcher, and a luminance adjuster. The display unit is configured to display a camera image of a peripheral view field of a vehicle captured with an on-vehicle camera. The optical mirror is disposed adjacent to a liquid crystal panel and is configured to reflect a reflected image of the peripheral view field. The mode switcher is configured to switch between a mirror mode for visual recognition of the peripheral view field with use of the reflected image in the optical mirror, and a display mode for visual recognition of the peripheral view field with use of the camera image on the display unit. The luminance adjuster is configured to adjust luminance of the display unit between a first luminance threshold for satisfying visibility and a second luminance threshold for reduction in deterioration of a backlight unit. The mode switcher is configured to switch from the display mode to the mirror mode when the first luminance threshold exceeds the second luminance threshold.

### TECHNICAL FIELD

The present invention relates to an electronic mirror apparatus that includes a display unit configured by a liquid crystal display and is applied for check of a periphery of a vehicle.

### BACKGROUND ART

There has been practically applied an on-vehicle display device (hereinafter, referred to as an “electronic mirror apparatus”) that includes a display unit configured to display a vehicle peripheral view field (e.g. a rear view field) imaged with an on-vehicle camera and is configured to enable visual recognition of the vehicle peripheral view field with use of a reflected image in an optical mirror or a camera image on the display unit. The display unit may be configured by a liquid crystal display including a liquid crystal panel and a backlight unit. The following description refers to a “mirror mode” for visual recognition of the peripheral view field with use of the reflected image in the optical mirror, and a “display mode” for visual recognition of the peripheral view field with use of the camera image on the display unit.

The liquid crystal display is known to undergo accelerated deterioration of a light emitting diode (LED) or the like configuring the backlight unit due to ambient temperature rise when the backlight unit is lit for a long period of time. In view of this, the backlight unit is limited in allowable luminance when driven in a high temperature environment in order to reduce deterioration of the backlight unit (e.g. PTL 1). Specifically, PTL 1 discloses lowering allowable maximum luminance of a backlight unit as ambient temperature of the backlight unit rises.

The backlight unit in the liquid crystal display has satisfied minimum luminance set to avoid deterioration in visibility. In a high temperature environment causing accelerated deterioration of the backlight unit, luminance of the backlight unit is adjusted within a range from the satisfied minimum luminance to the allowable maximum luminance.

### CITATION LIST

### Patent Literature

PTL 1: Unexamined Japanese Patent Publication No. 2007-219008

### SUMMARY OF THE INVENTION

The present invention provides an electronic mirror apparatus that reduces deterioration of a backlight unit in a liquid crystal display and in order to provide visibility of the vehicle rear view field of a vehicle peripheral view field.

The electronic mirror apparatus according to the present invention includes a display unit, an optical mirror, a mode switcher, and a luminance adjuster. The display unit is configured to display a camera image of a peripheral view field of a vehicle captured with an on-vehicle camera. The optical mirror is disposed on a display surface of the display unit and is configured to reflect a reflected image of the peripheral view field. The mode switcher is configured to switch between a mirror mode for visual recognition of the peripheral view field with use of the reflected image in the optical mirror, and a display mode for visual recognition of the peripheral view field with use of the camera image on the display unit. The luminance adjuster adjusts luminance of the display unit between a first luminance threshold for satisfying visibility and a second luminance threshold for reduction in deterioration of the display unit. The mode switcher is configured to switch from the display mode to the mirror mode when the first luminance threshold exceeds the second luminance threshold.

The present invention achieves reduction in deterioration of the backlight unit in the liquid crystal display and provided visibility of the vehicle peripheral view field.

### BRIEF DESCRIPTION OF DRAWINGS

FIG. 1 is a view depicting an installation condition of an electronic mirror apparatus according to an exemplary embodiment.

FIG. 2 is a diagram depicting an exemplary configuration of the electronic mirror apparatus according to the exemplary embodiment.

FIG. 3 is a flowchart exemplarily depicting display processing executed by the electronic mirror apparatus.

### DESCRIPTION OF EMBODIMENT

Problems of a conventional technique will be briefly described prior to description of an exemplary embodiment of the present invention. In a case where allowable maximum luminance is set along with rise in ambient temperature of a backlight unit, satisfied minimum luminance cannot be necessarily provided. The satisfied minimum luminance may not be provided in an exemplary case where the satisfied minimum luminance is too high with high ambient illuminance or where the allowable maximum luminance is too low with high ambient temperature of the backlight unit. In this case, visibility lowers if deterioration of the backlight unit is preferentially reduced, or deterioration of the backlight unit is accelerated if visibility is prioritized. A conventional electronic mirror apparatus accordingly fails to achieve both of the reduction in deterioration of the backlight unit in a liquid crystal display and providing of visibility of a vehicle peripheral view field.

An exemplary embodiment of the present invention will be described hereinafter with reference to the drawings.

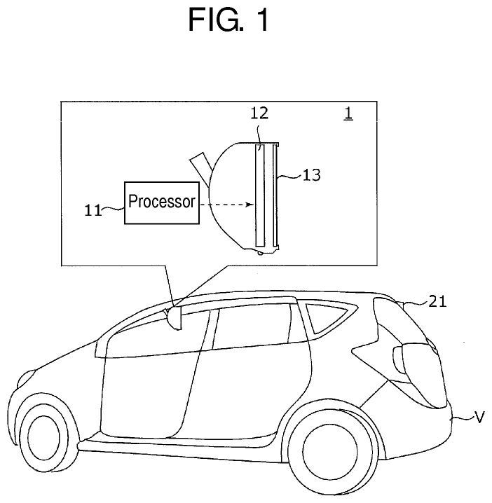

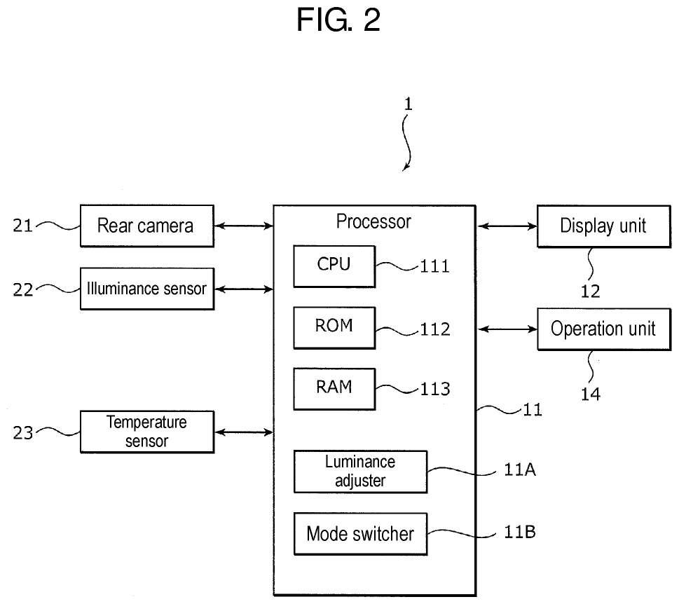

FIG. 1 is a view depicting an installation condition of electronic mirror apparatus 1 according to the exemplary embodiment. FIG. 2 is a diagram depicting an exemplary configuration of electronic mirror apparatus 1. Electronic mirror apparatus 1 may be attached at a center in an upper portion (where a windshield rear-view mirror is typically attached) of a windshield in an interior of vehicle V, and is used to check a rear view field of the vehicle.

As depicted in FIG. 1 and FIG. 2, electronic mirror apparatus 1 includes processor 11, display unit 12, optical mirror 13, operation unit 14, rear camera 21, illuminance sensor 22, temperature sensor 23, and the like. Rear camera 21, illuminance sensor 22, and temperature sensor 23 may be configured by existing equipment of vehicle V.

Rear camera 21 includes an imaging element such as a charge-coupled device (CCD) image sensor or a complementary metal oxide semiconductor (CMOS) image sensor. An electric signal photoelectrically converted by the imaging element and indicating an image of the rear view field is transmitted to electronic mirror apparatus 1 by means of wireless or wired communication.

Illuminance sensor 22 detects illuminance around display unit 12. Satisfied minimum luminance L1 (a first luminance threshold) of a backlight unit is set in accordance with a detection result (ambient illuminance) of illuminance sensor 22. Satisfied minimum luminance L1 for a plurality of ambient illuminance values is obtained preliminarily and experimentally and is stored in read only memory (ROM) 112 or the like. Satisfied minimum luminance L1 is set to be higher as ambient illuminance increases. Satisfied minimum luminance L1 may alternatively have a constant value regardless of the ambient illuminance.

Temperature sensor 23 detects ambient temperature of the backlight unit. Allowable maximum luminance L2 (a second luminance threshold) of the backlight unit is set in accordance with a detection result (ambient temperature) of temperature sensor 23. Allowable maximum luminance L2 for a plurality of ambient temperature values is obtained preliminarily and experimentally and is stored in ROM 112 or the like. Allowable maximum luminance L2 is not set if the ambient temperature is less than a predetermined threshold (e.g. 80° C.). Allowable maximum luminance L2 may alternatively have a constant value regardless of the ambient temperature.

Display unit 12 is configured by a liquid crystal display including a liquid crystal panel and the backlight unit (not depicted). The liquid crystal panel has an outer shape that is similar to an outer shape of optical mirror 13 or matches a display area.

Optical mirror 13 is disposed at a forefront face (in an opening of a housing (no reference mark given)). Display unit 12 is disposed at a rear face (inside the housing) of optical mirror 13. Optical mirror 13 is an optical member configured to reflect incident light from a front face and allow incident light from the rear face to be transmitted through optical mirror 13. Examples of optical mirror 13 include a semitransparent mirror having reflectance and transmittance equal to each other.

Electronic mirror apparatus 1 has a display mode for visual recognition of the rear view field with use of a camera image on display unit 12 and a mirror mode for visual recognition of the rear view field with use of a reflected image in optical mirror 13. In the display mode, display unit 12 is in an ON state and a user (e.g. a driver) visually recognizes the camera image on display unit 12 through optical mirror 13. In the mirror mode, display unit 12 is in an OFF state and the user visually recognizes the reflected image in optical mirror 13.

Switching between the display mode and the mirror mode may be executed interlockingly with operation of the operation unit 14. The present exemplary embodiment further includes forcibly switching from the display mode to the mirror mode in accordance with whether or not luminance of the backlight unit is adjustable.

Processor 11 includes central processing unit (CPU) 111, read only memory (ROM) 112, random access memory (RAM) 113, and the like. ROM 112 stores programs applied for achievement of functions, and basic setting data. CPU 111 reads a program adapted to a processing content from ROM 112, develops the program in RAM 113, and executes centralized control of behavior of each block in electronic mirror apparatus 1 in cooperation with the developed program. Processor 11 functions as luminance adjuster 11A and mode switcher 11B.

Luminance adjuster 11A adjusts the luminance of the backlight unit in display unit 12. Specifically, luminance adjuster 11A controls current flowing to an LED configuring the backlight unit to adjust the luminance of the backlight unit. The current flowing to the LED is adjusted by means of pulse width modulation (PWM) control.

Luminance adjuster 11A controls the current flowing to the LED such that the luminance of the backlight unit is higher than satisfied minimum luminance L1, in order to avoid deterioration in visibility of the camera image. Luminance adjuster 11A controls the current flowing to the LED such that the luminance of the backlight unit does not exceed allowable maximum luminance L2 in a high temperature environment, in order to reduce deterioration of the backlight unit. The luminance of the backlight unit accordingly falls within a range from satisfied minimum luminance L1 to allowable maximum luminance L2 in a high temperature environment.

Satisfied minimum luminance L and allowable maximum luminance L2 are set independently from each other, and satisfied minimum luminance L1 may thus exceed allowable maximum luminance L2. In such a case, luminance adjuster 11A fails to adjust the luminance of the backlight unit so as to reduce deterioration of the backlight unit while providing visibility of the camera image.

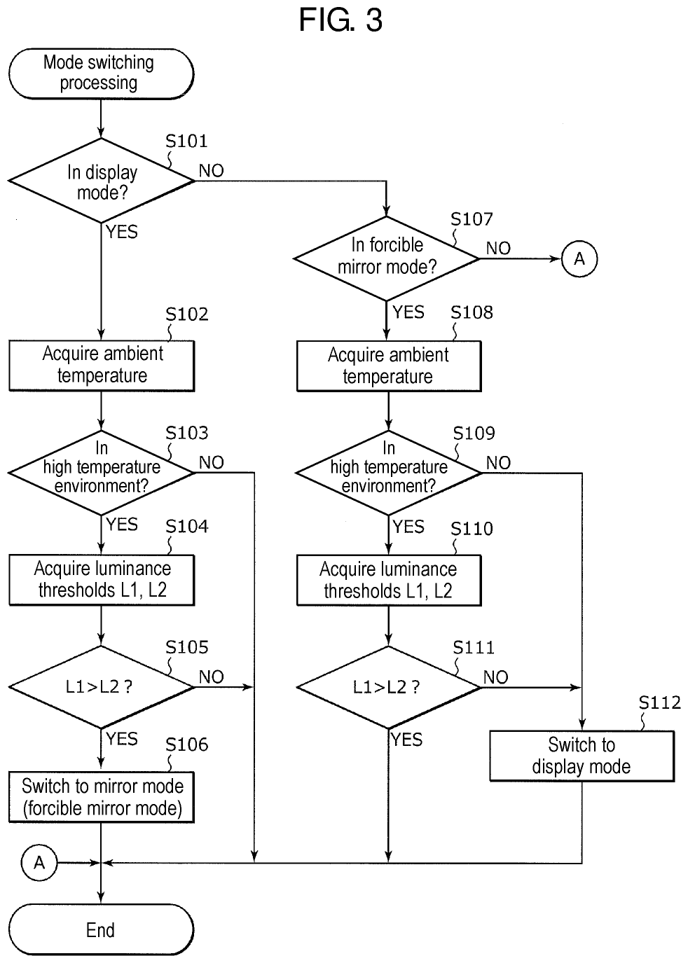

Mode switcher 11B automatically switches between the display mode and the mirror mode in accordance with whether or not luminance adjuster 11A is capable of adjusting the luminance of the backlight unit. Mode switcher 11B will be detailed in terms of its function with reference to a flowchart depicted in FIG. 3.

FIG. 3 is a flowchart exemplarily depicting mode switching processing executed by processor 11. In order to achieve this processing, electronic mirror apparatus 1 is started along with start of a power source (an engine or a motor) of the vehicle and CPU 111 reads a mode switching program stored in ROM 112 and executes the program. The mode switching processing is executed repetitively while the vehicle is traveling.

In step S101, processor 11 determines whether or not the display mode is effected. If the display mode is effected (“YES” in step S101), the process flow proceeds to step S102. If the display mode is not effected (“NO” in step S101), the process flow proceeds to step S107.

In step S102, processor 11 acquires ambient temperature of the backlight unit in accordance with a detection signal from temperature sensor 23.

In step S103, processor 11 determines whether or not the backlight unit is driven in a high temperature environment. Processor 11 compares the ambient temperature of the backlight unit with the predetermined threshold (e.g. 80° C.), and determines that the backlight unit is driven in a high temperature environment if the ambient temperature is more than the threshold. If the backlight unit is driven in a high temperature environment (“YES” in step S103), the process flow proceeds to step S104. If the backlight unit is not driven in a high temperature environment (“NO” in step S103), the mode switching processing is completed. Allowable maximum luminance L2 is not set and luminance adjuster 11A is capable of appropriately adjusting the luminance of the backlight unit in this case, so that the display mode is continuously effected.

In step S104, processor 11 acquires satisfied minimum luminance L1 (the first luminance threshold) and allowable maximum luminance L2 (the second luminance threshold). Satisfied minimum luminance L1 is set in accordance with current ambient illuminance. Allowable maximum luminance L2 is set in accordance with current ambient temperature.

In step S105, processor 11 determines whether or not satisfied minimum luminance L1 exceeds allowable maximum luminance L2. If satisfied minimum luminance L1 exceeds allowable maximum luminance L2 (“YES” in step S105), luminance adjuster 11A is incapable of adjusting luminance. The process flow proceeds to step S106 in this case. If satisfied minimum luminance L1 does not exceed allowable maximum luminance L2 (“NO” in step S105), luminance adjuster 11A is capable of appropriately adjusting the luminance of the backlight unit and the mode switching processing is accordingly completed. The display mode is continuously effected in this case.

In step S106, processor 11 switches from the display mode to the mirror mode. If satisfied minimum luminance L1 exceeds allowable maximum luminance L2, luminance adjuster 11A is incapable of appropriately adjusting the luminance of the backlight unit. The camera image may have deterioration in visibility and cause safety risks in this case. The electronic mirror apparatus is thus switched to the mirror mode to cause the user to visually recognize the reflected image in optical mirror 13 in order to provide visibility of the vehicle rear view field.

After the electronic mirror apparatus is switched from the display mode to the mirror mode in this manner, luminance adjuster 11A becomes capable of appropriately adjusting luminance if satisfied minimum luminance L1 becomes less than or equal to allowable maximum luminance L2 due to at least one of decrease in ambient temperature of the backlight unit and decrease in ambient illuminance of display unit 12. There occurs switching in a visual recognition mode from the mirror mode to the display mode in this case. Executed in step S107 to step S112 is processing of returning from the mirror mode to the display mode.

In step S107, processor 11 determines whether or not a forcible mirror mode is effected. The forcible mirror mode is a mirror mode set through automatic switching in step S106, and does not include the mirror mode manually set by the user. If the forcible mirror mode is effected (“YES” in step S107), the process flow proceeds to step S108. If the forcible mirror mode is not effected (“NO” in step S107), the mode switching processing is completed. When the user manually sets the mirror mode, switching from the mirror mode to the display mode will not occur in view of intention of the user.

In step S108, processor 11 acquires ambient temperature of the backlight unit in accordance with a detection signal from temperature sensor 23.

In step S109, processor 11 determines whether or not the backlight unit is driven in a high temperature environment. Processor 11 compares the ambient temperature of the backlight unit with the predetermined threshold (e.g. 80° C.), and determines that the backlight unit is driven in a high temperature environment if the ambient temperature is more than the threshold. If the backlight unit is driven in a high temperature environment (“YES” in step S109), the process flow proceeds to step S110. If the backlight unit is not driven in a high temperature environment (“NO” in step S109), in other words, if use environment has transition from a high temperature environment to a low temperature environment, the process flow proceeds to step S112.

The threshold of ambient temperature, which is a determination criterion in step S109 and step S103 as to whether or not the use environment is a high temperature environment, is preferred to have a maximum hysteresis error. This prevents frequent switching of the visual recognition mode and rather leading to deterioration in visibility.

In step S110, processor 11 acquires satisfied minimum luminance L1 (the first luminance threshold) and allowable maximum luminance L2 (the second luminance threshold).

In step S111, processor 11 determines whether or not satisfied minimum luminance L1 exceeds allowable maximum luminance L2. Specifically, processor 11 determines whether or not luminance adjuster 11A is continuously incapable of appropriately adjusting luminance. In a case where satisfied minimum luminance L1 exceeds allowable maximum luminance L2 (“YES” in step S111), the mode switching processing is completed. The forcible mirror mode is continuously effected in this case. In another case where satisfied minimum luminance L does not exceed allowable maximum luminance L2 (“NO” in step S111), luminance adjuster 11A is capable of appropriately adjusting the luminance of the backlight unit and the process flow accordingly proceeds to step S112.

Allowable maximum luminance L2, which is a criterion for comparison with satisfied minimum luminance L1 in step S105 and step S111, is preferred to have a maximum hysteresis error. This prevents frequent switching of the visual recognition mode and rather leading to deterioration in visibility.

In step S112, processor 11 switches from the mirror mode to the display mode. If satisfied minimum luminance L1 does not exceed allowable maximum luminance L2, in other words, if luminance adjuster 11A becomes capable of adjusting the luminance of the backlight unit to be more than or equal to the satisfied minimum luminance, the visual recognition mode is returned to the display mode. The camera image in the display mode is subjected to light control and is thus useful as a glareproof measure in a case where a following vehicle emits glaring headlight.

Switching from the display mode to the mirror mode and returning from the mirror mode to the display mode are executed as described above.

Electronic mirror apparatus 1 includes display unit 12, optical mirror 13, mode switcher 11B, and luminance adjuster 11A. Display unit 12 includes the liquid crystal panel and the backlight unit, and displays a camera image of the vehicle rear view field (peripheral view field) captured with rear camera 21 (on-vehicle camera). Optical mirror 13 is disposed adjacent to the liquid crystal panel and is configured to reflect a reflected image of the rear view field. Mode switcher 11B switches between the mirror mode for visual recognition of the rear view field with use of the reflected image in optical mirror 13, and the display mode for visual recognition of the rear view field with use of the camera image on display unit 12. Luminance adjuster 11A adjusts luminance of the backlight unit to fall between satisfied minimum luminance L1 (the first luminance threshold) for satisfying visibility and the allowable maximum luminance (the second luminance threshold) for reduction in deterioration of the backlight unit. Mode switcher 11B switches from the display mode to the mirror mode when satisfied minimum luminance L1 exceeds allowable maximum luminance L2.

Electronic mirror apparatus 1 typically provides a camera image in the display mode for visual recognition of the rear view field, and is switched to the mirror mode for visual recognition of the rear view field with use of a reflected image in the optical mirror when visibility is not provided in a high temperature environment possibly accelerating deterioration of the backlight unit. This configuration achieves reduction in deterioration of the backlight unit in the liquid crystal display and provided visibility of the vehicle peripheral view field.

The invention achieved by the inventors of the present invention has been specifically described with reference to the exemplary embodiment. The present invention should not be limited to the exemplary embodiment but can be modified within a scope not departing from a purpose of the present invention.

For example, the exemplary embodiment refers to automatically returning to the display mode after switching from the display mode to the mirror mode. Alternatively, when luminance adjuster 11A becomes capable of appropriately adjusting luminance, the user may be notified of the capability from a notification unit and operate to switch to the display mode. The notification unit may display, on display unit 12, information indicating that the visual recognition mode is switchable to the display mode, or may notify by means of audio information.

The present invention is also applicable to an electronic mirror apparatus that substitutes for a sideview mirror and includes a display unit configured to display a camera image of a vehicle rear lateral view field captured with a side camera, and an optical mirror disposed adjacent to a liquid crystal panel and configured to reflect a reflected image of the rear lateral view field.

Processor 11 (computer) according to the exemplary embodiment functions as luminance adjuster 11A and mode switcher 11B to achieve the present invention. Part or all of these functions may alternatively be achieved with an electronic circuit such as a digital signal processor (DSP), an application specific integrated circuit (ASIC), or a programmable logic device (PLD).

The exemplary embodiment exemplarily provides display unit 12 configured by the liquid crystal display including the backlight unit and the liquid crystal panel. Display unit 12 may alternatively be configured by a self-luminous display such as an organic electroluminescence device. Even in such a case where the electronic mirror apparatus includes a self-luminous display, satisfied minimum luminance L1 (the first luminance threshold) for satisfying visibility and allowable maximum luminance L2 (the second luminance threshold) for reduction in deterioration of members in the display unit may be provided and the electronic mirror apparatus may be switched from the display mode to the mirror mode if satisfied minimum luminance L1 exceeds allowable maximum luminance L2.

The exemplary embodiment disclosed herein should be regarded as being exemplary and nonrestrictive in every aspect. The scope of the present invention is represented not by the above description but by the claims, and is intended to involve all modifications within the sense and scope equivalent to the claims.

### INDUSTRIAL APPLICABILITY

The present invention is preferably applicable to an electronic mirror apparatus that includes a display unit configured by a liquid crystal display and is applied for check of a periphery of a vehicle.

### REFERENCE MARKS IN THE DRAWINGS

1: electronic mirror apparatus
11: processor
11A: luminance adjuster
11B: mode switcher
12: display unit (liquid crystal display)
13: optical mirror
14: operation unit
21: rear camera (on-vehicle camera)
22: illuminance sensor
23: temperature sensor
111: CPU
112: ROM
113: RAM
V: vehicle

1. An electronic mirror apparatus comprising:
a display unit that displays a camera image of a peripheral view field of a vehicle, the camera image being captured with an on-vehicle camera;
an optical mirror disposed on a display surface of the display unit and that reflects a reflected image of the peripheral view field;
a mode switcher that switches between a mirror mode for visual recognition of the peripheral view field with use of the reflected image in the optical mirror, and a display mode for visual recognition of the peripheral view field with use of the camera image on the display unit; and
a luminance adjuster adjusts luminance of the display unit between a first luminance threshold for satisfying visibility and a second luminance threshold for reduction in deterioration of the display unit, wherein
the mode switcher switches from the display mode to the mirror mode when the first luminance threshold exceeds the second luminance threshold.

2. The electronic mirror apparatus according to claim 1, wherein the first luminance threshold is set in accordance with ambient illuminance of the display unit.

3. The electronic mirror apparatus according to claim 1, wherein the second luminance threshold is set in accordance with ambient temperature of the display unit.

4. The electronic mirror apparatus according to claim 1, wherein the mode switcher switches from the mirror mode to the display mode when the luminance adjuster becomes capable of adjusting luminance of the display unit at more than or equal to the first luminance threshold.

5. The electronic mirror apparatus according to claim 1, further comprising a notification unit configured to notify a user that the luminance adjuster becomes capable of adjusting luminance of the display unit at more than or equal to the first luminance threshold, wherein
the mode switcher switches from the mirror mode to the display mode in accordance with user operation.

6. An electronic mirror apparatus comprising:
a display having a display area for display of an image of a peripheral view field of a vehicle and the peripheral view field being captured with a camera mounted on the vehicle;
an optical mirror disposed to face the display area, allow incident light from the display area to be transmitted through the optical mirror, and reflect incident light incident from a direction opposite to the display area;
a mode switcher switches between a mirror mode of stopping display of the image on the display, and a display mode of displaying the image on the display;
a first sensor;
a second sensor; and
a luminance adjuster adjusts luminance of the display between a first luminance threshold for satisfying visibility and a second luminance threshold for reduction in deterioration of the display, the first luminance threshold being set in accordance with a current detection result of the first sensor, the second luminance threshold being set in accordance with a current detection result of the second sensor, wherein
the mode switcher switches from the display mode to the mirror mode when the first luminance threshold exceeds the second luminance threshold.

7. The electronic mirror apparatus according to claim 6, wherein the mode switcher switches from the mirror mode to the display mode when the second luminance threshold is more than or equal to the first luminance threshold.

8. The electronic mirror apparatus according to claim 6, further comprising a notification unit that notifies a user that the luminance of the display is adjustable when the second luminance threshold is-more than or equal to the first luminance threshold,
wherein
the mode switcher switches from the mirror mode to the display mode in accordance with operation of the user.
